(19) United States
(12) Patent Application Publication
(10) Pub. No.: US 2008/0223311 A1
(43) Pub. Date: Sep. 18, 2008

(54) PET HARNESS

(75) Inventor: Tetsuya Ito, Tokyo (JP)

Correspondence Address: DARBY & DARBY P.C., P.O. BOX 770, Church Street Station, New York, NY, 10008-0770, US

(73) Assignee: THREE ARROWS INC., Tokyo (JP)

(21) Appl. No.: 11/829,245

(22) Filed: Jul. 27, 2007

(30) Foreign Application Priority Data
Mar. 15, 2007 (JP) 2007-67090

(51) Int. Cl. A01K 27/00

(52) U.S. Cl. 119/792

(57) ABSTRACT

Compared with the collar only, the conventional pet harness can disperse the force applied from the lead to the pet and reduce the burden on the pet. However, since it uses narrow belts as straps, it has a problem that when a large force is applied, the straps thrust into the skin of the pet, to give a pain. Further, a wide piece consisting of a collar portion, a body loop portion and an underside portion is proposed, but it has a problem that it is troublesome to install and remove the harness on and from the pet.

The present invention proposes a pet harness, characterized in that engagement members 4 and lead attaching members 5 are attached at both the ends of a body strap 3 destined to form a body loop 6, that a pinafore-like collar 7 is connected between both the ends of said body strap, and that a connecting strap 8 is connected between the bottom of the central portion of the pinafore-like collar and the body strap in such a manner that the connecting strap can be moved relatively to said body strap.

### FIELD OF THE INVENTION

The present invention relates to a harness used for taking a pet such as a dog outdoors.

### BACKGROUND OF THE INVENTION

The conventional pet harnesses include those disclosed, for example, in Patent Document 1, JP Patent No. 2506285B and Patent Document 2, JP2001-69869A.

Each of the pet harnesses has a pair of straps (for example, belts) for encircling the neck and the body of a pet, and the ends of both the straps are engaged with each by means of engagement members at the back of the pet. The engagement members have connecting straps and connecting rings to be connected with the lead. Further, lest the straps provided as a pair should move too far away from each other beyond a certain distance when the harness is worn by the pet, a distance regulating strap is connected between the central portions of the straps provided as a pair.

In the case where a pet wears the harness as described above, since the pair of straps supports the neck and the body of the pet, the force acting on the pet can be dispersed compared with the use of a collar only, to reduce the burden on the pet. However, the harness has a problem that since the respective straps are narrow belts, any large force happening to act on the pet can cause the straps, especially the strap around the neck to thrust into the skin of the pet, giving a pain.

Patent Document 3, JP2002-330659A makes a proposal with an intention to solve the problem. The conventional harness described in Patent Document 3 will be explained below in reference to FIGS. 12 and 13.

The harness X is provided as an integral wide piece consisting of a collar portion 101, a body loop portion 102 and an underside portion 103. Further, the tip 101a of the collar portion 101 and the tip 102a of the body loop portion on one side are connected with each other by a belt 104a, and the tip 101b of the collar portion and the tip 102b of the body loop portion on the other side are connected with each other by a belt 104b. Furthermore, a ring 105a and a ring 105b are fitted loosely around the belt 104a and the belt 104b respectively, and a lead attaching belt 107 is inserted through the rings 105a and 105b and both the ends of the lead attaching belt 107 are joined to form a loop and fastened at an adequate position by a clamp 106. A lead 108 is connected with the lead attaching belt 107, for example, through a ring 109.

In the case where a pet wears the harness X, if the clamp 106 is loosened to pull the lead attaching belt 107 in the direction to make the pair of rings 105a and 105b closer to each other, the harness can fit the body of the pet.

However, when the harness X is installed on and removed from a pet 110, it is necessary to loosen the clamp 106 of the lead attaching belt 107, to move the pair of rings 105a and 105b away from each other. So this conventional harness has a problem that unless the adjustable range is sufficiently large, it is difficult to install the harness X on the pet 110 and to remove it from the pet, and the operation is troublesome. Even if the adjustable range is sufficiently large, there is another problem that since the pair of rings 105a and 105b is not liberated from the lead attaching belt 107, the installation and removal of the harness X on and from the pet 110 cannot be smoothly performed.

The harness of Patent Document 3 can reduce the burden on the pet to some extent compared with the conventional harnesses proposed in Patent Documents 1 and 2, etc., as described above. However, in the case where narrow belts are used as the straps, if a large force is applied to the pet, for example, by strongly pulling the lead, it cannot be avoided that the straps thrust into the skin of the pet, to give a pain. Further, the integral wide piece consisting of a collar portion, a body loop portion and an underside portion as proposed in Patent Document 3 can further reduce the thrust into the skin of the pet, but this harness has a problem that it is troublesome to install and remove the harness on and from the pet.

The object of this invention is to solve these problems.

### SUMMARY OF THE INVENTION

To solve the above problems, this invention proposes a pet harness, characterized in that engagement members and lead attaching members are attached at both the ends of a body strap destined to form a body loop, that a pinafore-like collar is connected between both the ends of said body strap, and that a connecting strap is connected between the bottom of the central portion of the pinafore-like collar and the body strap in such a manner that the connecting strap can be moved relatively to said body strap.

This invention further proposes a pet harness with the above constitution, wherein the engagement members attached at both the ends of the body strap are engagement members of an unfastenable buckle.

Furthermore, this invention proposes a pet harness with the above constitution, wherein said body strap is adjustable in length.

Moreover, this invention proposes a pet harness with the above constitution, wherein the connecting member is adjustable in length.

Moreover, this invention proposes a pet harness with the above constitution, wherein the pinafore-like collar is a Y-shaped wide member projecting downward in the central portion. The pinafore-like collar can have a decorative hole formed in it.

In the pet harness of this invention, both the ends of the body strap are engaged with each other by means of engagement members such as engagement members of an unfastenable buckle. Therefore, the installation of the harness on and removal from the pet are very simple since it is only required to connect and disconnect the engagement members.

Further, since the pinafore-like collar connected between both the ends of the body strap is a Y-shaped wide piece projecting downward at the central portion, the force applied to the pet from the lead can be dispersed to the entire chest of the pet, and the burden on the pet can be remarkably reduced compared with a narrow belt, etc.

The connecting strap connected between the bottom of the central portion of the pinafore-like collar and the body strap adequately maintains the distance between the pinafore-like collar and the body strap and prevents the portion projecting downward at the bottom of the central portion of the pinafore-like collar from drooping when the harness is worn, and the pinafore-like collar and the body strap can appropriately support the force applied from the lead to the pet.

Since the connecting strap can be adjusted in length using an appropriate length adjuster such as a strap length adjuster, its length can be adjusted to suit the body of the pet.

When the harness is worn by the pet, both the ends of the body strap are engaged with each other by the engagement members of a buckle, etc. so that the body strap encircles the body of the pet. If the length of the body strap is too short compared with the body circumference of the pet, the pet will feel tightness. If the length of the body strap is too long, a clearance will be formed between the body strap and the body circumference of the pet, and since the force applied from the lead to the pet can act suddenly, the pet will feel a pain. So, it is necessary to adjust the length of the body strap for adaptation to the body circumference of the pet. In this invention, since the length of the body strap can be adjusted by an appropriate length adjuster such as a strap length adjuster, the body strap can be adjusted in length to suit the body circumference of each pet.

Furthermore, in this invention, the connecting strap is provided to allow relative movement to the body strap. So, even if the length of the body strap is adjusted to suit the body circumference of the pet, such adverse influence as twisting or bending the connecting strap and the pinafore-like collar can be avoided.

### BRIEF DESCRIPTION OF THE DRAWINGS

FIG. 1 is a front view showing a mode of the pet harness of this invention in which the engagement members are engaged with each other.

FIG. 2 is a plan view showing a mode of the pet harness of this invention in which the engagement members are not engaged with each other.

FIG. 3 is a front view showing a mode of the pet harness of this invention in which the engagement members are engaged with each other.

FIG. 4 is a left side view showing a mode of the pet harness of this invention in which the engagement members are engaged with each other.

FIG. 5 is a bottom view showing a mode of the pet harness of this invention in which the engagement members are engaged with each other.

FIG. 6 is an A-A line sectional view of FIG. 5.

FIG. 7 is a B-B line sectional view of FIG. 5.

FIG. 8 is an illustration showing the front of the pet who wears the pet harness of this invention.

FIG. 9 is an illustration showing the back of the pet who wears the pet harness of this invention.

FIG. 10 is an illustration showing a side of the pet who wears the pet harness of this invention.

FIG. 11 is a front view showing another mode of the pet harness of this invention in which the engagement members are engaged with each other.

FIG. 12 is an illustration showing a conventional pet harness.

FIG. 13 is an illustration showing a conventional pet harness worn by a pet.

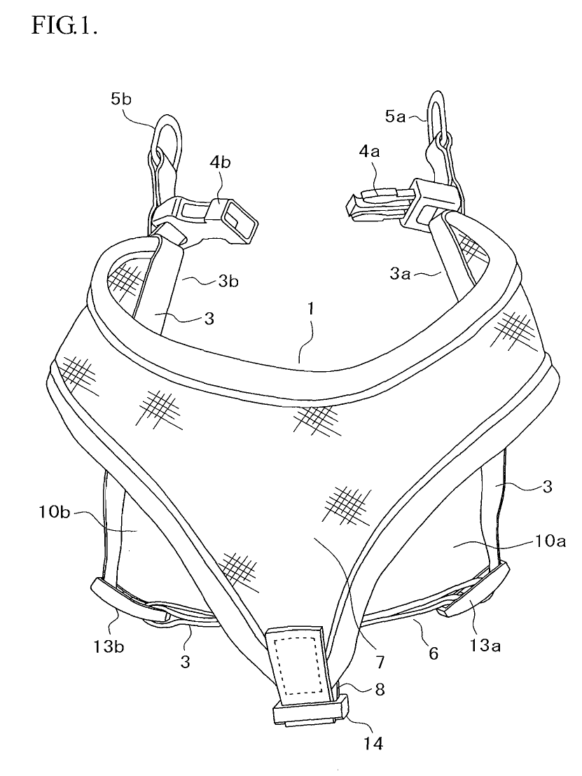

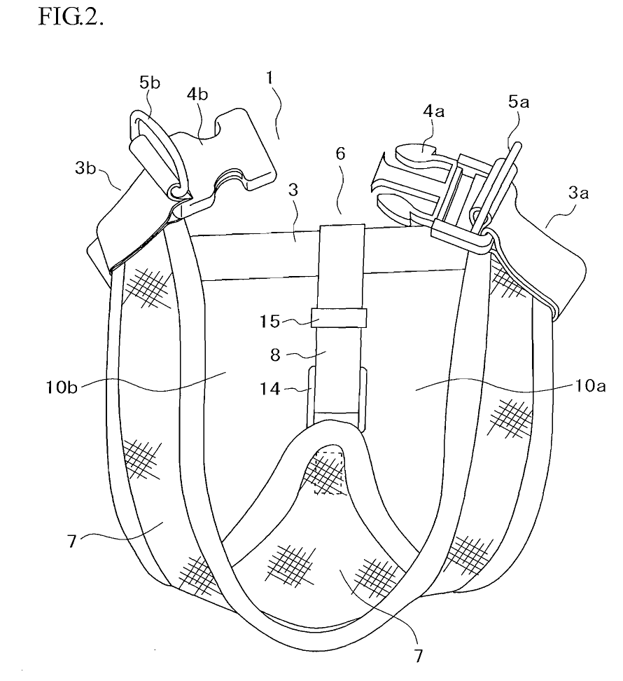

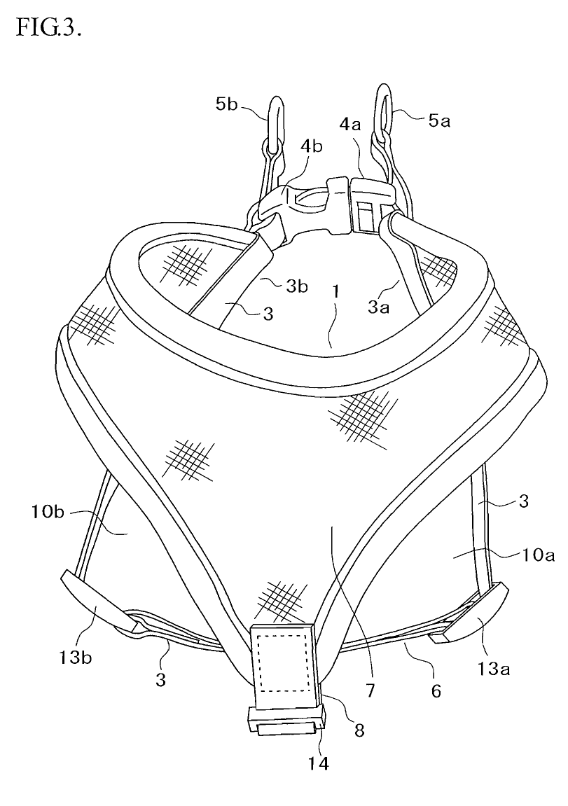

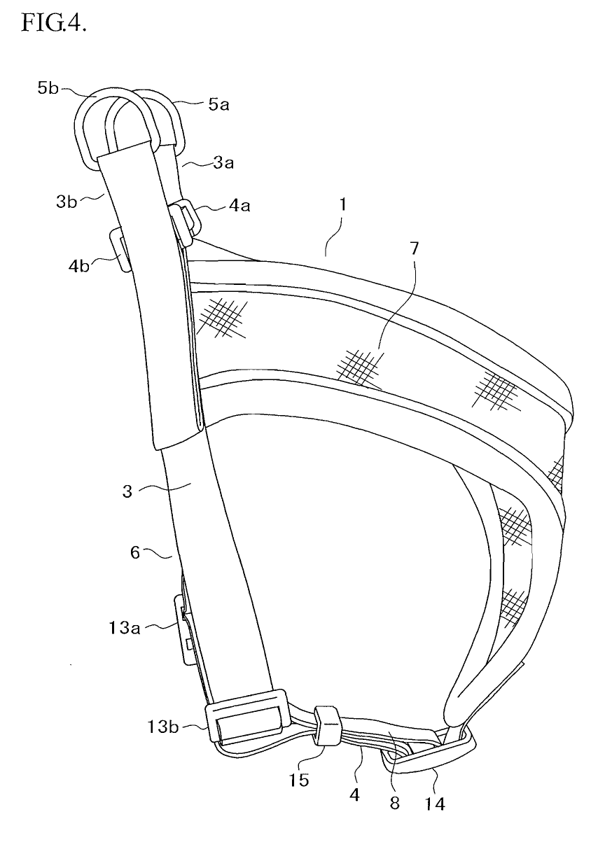

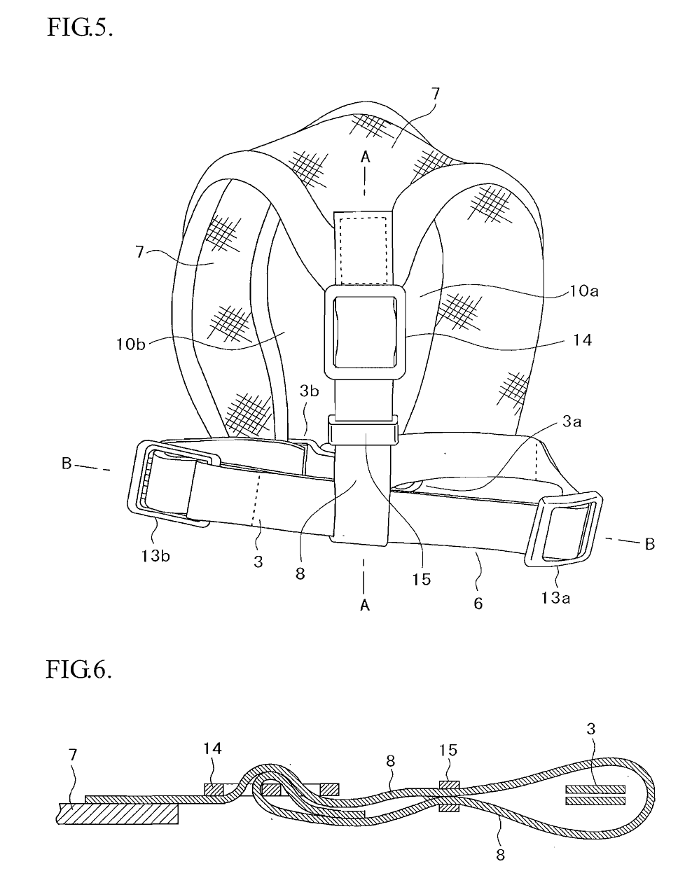

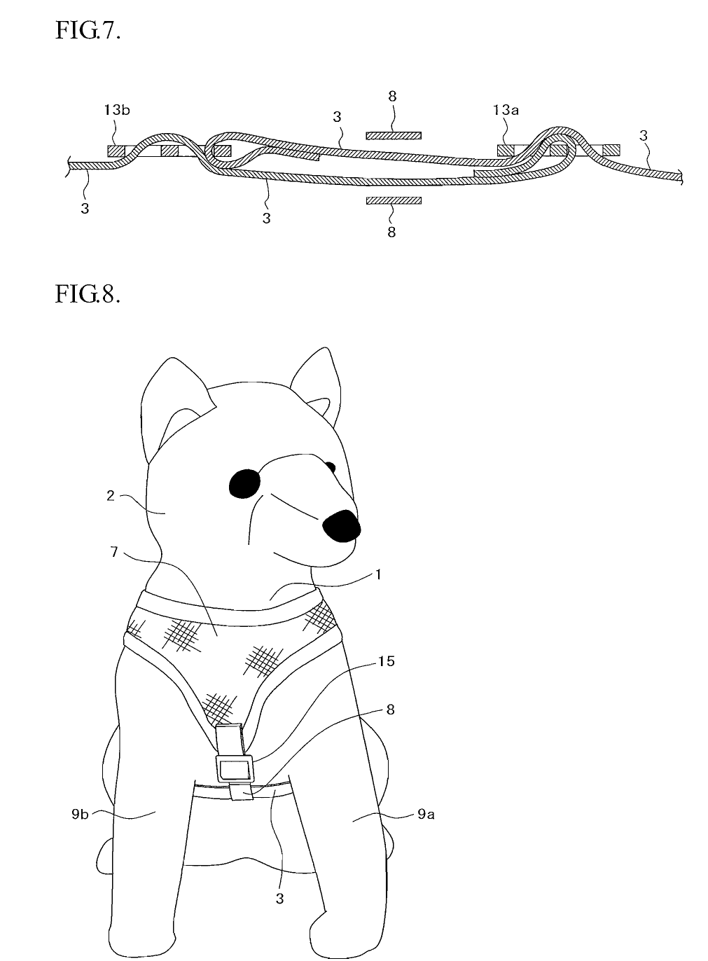

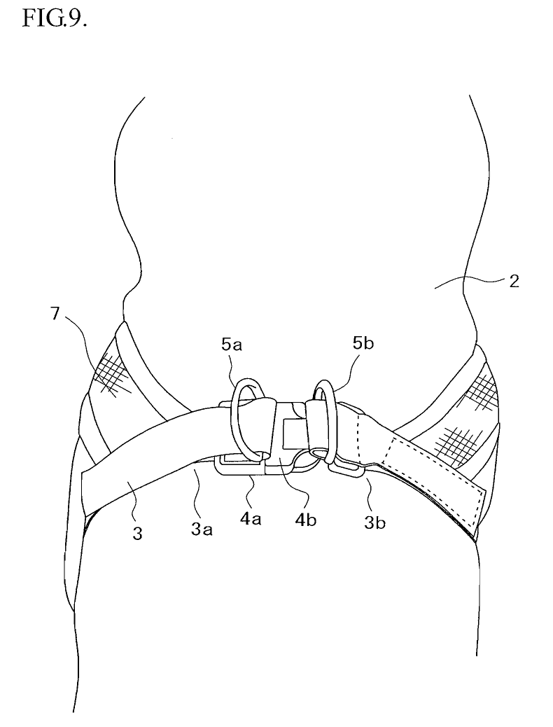

The best modes for carrying out this invention will be explained in reference to FIGS. 1 through 10. FIGS. 1 and 2 are a front view and a plan view of the harness of this invention in which the engagement members are not engaged with each other. FIGS. 3 through 5 are a front view, a left side view and a bottom view of the harness of this invention in which the engagement members are engaged with each other. FIG. 6 is an A-A line sectional view of FIG. 5, and FIG. 7 is a B-B line sectional view of FIG. 5. FIGS. 8 through 10 are illustrations showing states where the harness of this invention is worn by a pet.

As shown in the drawings, in a pet harness 1 of this invention, engagement members 4a and 4b and lead attaching members 5a and 5b are attached at both the ends 3a and 3b of a body strap.

As shown in FIG. 2, the engagement members 4a and 4b are engaged with each other so that the body strap 3 forms a body loop 6 as shown in FIG. 3. Further, between both the ends 3a and 3b of the body strap 3, a pinafore-like collar 7 is connected, and between the bottom of the central portion of the pinafore-like collar 7 and the body strap 3, a connecting strap 8 is connected in such a manner that the connecting strap can be moved relatively to the body strap 3.

The engagement members 4a and 4b in this example are male and female members of an unfastenable buckle, and when the pet harness 1 is installed on a pet 2, at first the engagement between the engagement members 4a and 4b is released. Then, the left fore leg 9a and the right fore leg 9b of the pet 2 are inserted through a left loop hole 10a and a right loop hole 10b respectively from the back side to the front side of the pet harness 1, so that the pinafore-like collar 7 fits the chest of the pet 2 while the body strap 3 fits the body of the pet 2 on the rear side of the fore legs 9. The engagement members 4a and 4b are engaged with each other to ensure that the pet harness 1 does not come off from the pet 2.

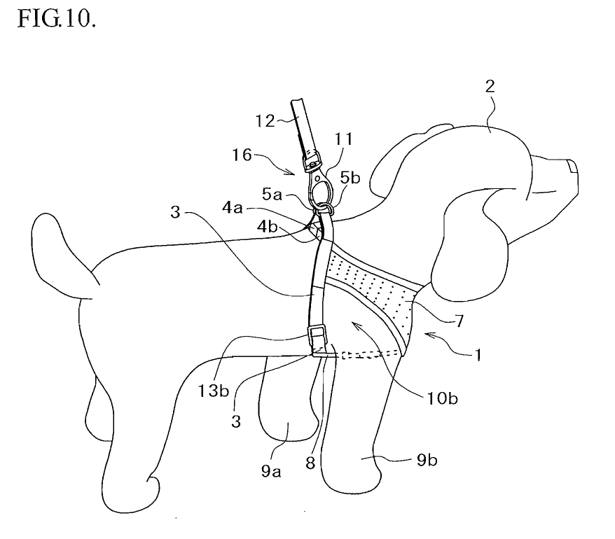

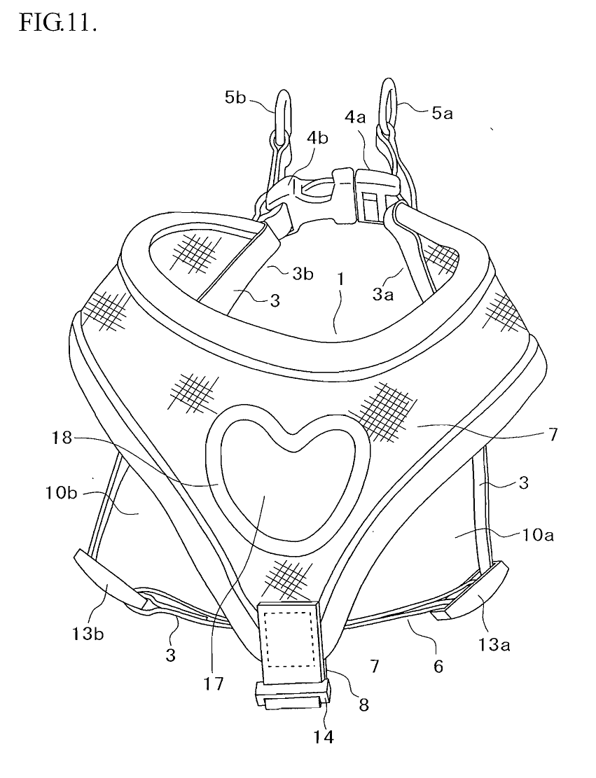

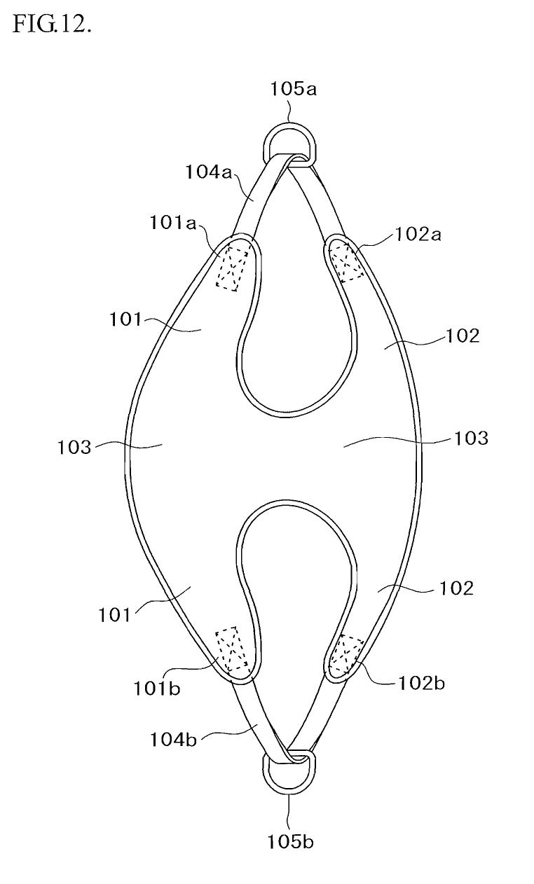

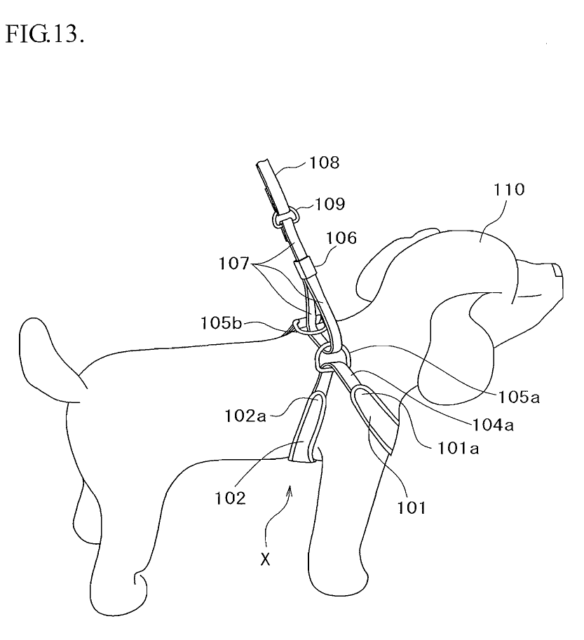

In this state of installation, the lead attaching members 5a and 5b are close to each other. So, if a lead 12 having a connector such as a hook 11 at the tip is prearranged, the hook 11 can catch the lead attaching members 5a and 5b together, to connect the lead 12 with the pet harness 1 as shown in FIG. 10. Now, the pet owner (not shown in the drawings) or the like can have the other end of the lead 12 and take the pet 2 outdoors safely and comfortably.

For removing the pet harness 1 from the pet after the pet 2 comes home, the operation reverse to the above can be performed. That is, the hook 11 of the lead 12 is removed from the lead attaching members 5a and 5b, and the engagement between the engagement members 4a and 4b is released. Then, the fore legs 9 of the pet 2 can be pulled out of the loop holes 10, to remove the pet harness 1 from the pet 2. So, the removal operation is as very simple as the installation operation.

The body strap 3, the pinafore-like collar 7, the connecting strap 8, etc. can be made of any appropriate material such as natural fibers, synthetic fibers or leather, if they have a moderate strength not allowing easy cutting or breaking when a strong force is applied and are friendly to the body of the pet 2.

The body strap 3 has a pair of length adjusters (strap length adjusters in this example) 13a and 13b on both sides, and if the length adjusters 13a and 13b are adjusted, the length of the body strap can be adjusted to suit the body circumference of the pet 2.

The connecting strap 8 connected between the bottom of the central portion of the pinafore-like collar 7 and the body strap 3 is provided with a length adjuster (strap length adjuster in this example) 14 and a holding member (swivel in this example) 15, so that the length of the connecting strap 8 can be adjusted. Meanwhile, the connecting strap 8 is not fastened to the body strap 3 by sewing or the like, but is formed to have a loop to be engaged with the body strap 3. So, it can be moved relatively to the body strap 3.

The lead attaching members 5a and 5b are metallic rings in this example, but they can also be strong plastic rings, etc.

FIG. 11 shows another mode for carrying out this invention, and in this mode, a decorative hole 17 with a hem 18 around it is formed in the pinafore-like collar 7. In this invention, an ornament can be attached to the pinafore-like collar 7 or a decorative hole 17 can be formed in it as described here for enhancing a decorative effect.

### INDUSTRIAL APPLICABILITY

As described above, the pet harness of this invention can remarkably reduce the burden on the pet caused by the force applied from the lead to the pet and can be very easily installed on and removed from the pet. Therefore, the pet owner can readily, easily and safely take the pet outdoors. It contributes to the health promotion of the pet loved by the owner, and as a result, the expensive medical expenses can be saved. So, the pet harness of this invention is highly industrially applicable.

What is claimed is:

1. A pet harness, characterized in that engagement members and lead attaching members are attached at both the ends of a body strap destined to form a body loop, that a pinafore-like collar is connected between both the ends of said body strap, and that a connecting strap is connected between the bottom of the central portion of the pinafore-like collar and the body strap in such a manner that the connecting strap can be moved relatively to said body strap.

2. A pet harness, according to claim 1, wherein the engagement members attached at both the ends of the body strap are engagement members of an unfastenable buckle.

3. A pet harness, according to claim 1, wherein said body strap is adjustable in length.

4. A pet harness, according to claim 1, wherein the connecting member is adjustable in length.

5. A pet harness, according to claim 1, wherein the pinafore-like collar is a Y-shaped wide piece projecting downward in the central portion.

6. A pet harness, according to claim 5, wherein the pinafore-like collar has a decorative hole formed in it.
